(19) United States
(12) Patent Application Publication
(10) Pub. No.: US 2014/0114259 A1
(43) Pub. Date: Apr. 24, 2014

(54) FEEDING TUBE EXTENSION

(71) Applicant: Katrina Durham, Salt Lake City, UT (US)

(72) Inventor: Katrina Durham, Salt Lake City, UT (US)

(21) Appl. No.: 14/061,463

(22) Filed: Oct. 23, 2013

Related U.S. Application Data
(60) Provisional application No. 61/718,114, filed on Oct. 24, 2012.

(51) Int. Cl. A61J 15/00

(52) U.S. Cl. CPC A61J 15/0069
USPC 604/250; 604/533

(57) ABSTRACT

A feeding tube extension may be used to extend the length of a feeding tube. The feeding tube extension may comprise an extension tube and a connector configured to be inserted into a feeding port of the feeding tube. So the flow of fluids is not unduly restricted, an inner diameter of the extension tube and a diameter of a connector lumen may be selected to be a predetermined size relative to the a diameter of a feeding tube lumen. A feeding syringe interface may facilitate use of a feeding syringe with the extension tube. Various mechanisms may be used to seal the extension tube when feeding is complete. A right-angle bolster and catheter securing device may be configured to secure the feeding tube so that it does not kink or move and cause irritation.

### RELATED APPLICATIONS

This application claims priority to U.S. Provisional Patent Application Ser. No. 61/718,114 filed Oct. 24, 2012, which is hereby incorporated by reference herein in its entirety.

### TECHNICAL FIELD

This application relates to methods, apparatuses, and kits for extending enteral feeding tubes.

### BRIEF DESCRIPTION OF THE DRAWINGS

FIG. 1 is a side perspective view of a first gastric feeding tube.

FIG. 2 is a side perspective view of a second gastric feeding tube.

FIG. 3 is a cross-section view of the second gastric feeding tube inserted into a stoma in an abdominal wall and stomach wall of the patient.

FIG. 4 is a side perspective view of a feeding tube extension for extending the length of a feeding tube.

FIG. 5 is a side perspective view of the feeding tube extension coupling to the second gastric feeding tube.

FIG. 6 is a side perspective view of the feeding tube extension with a feeding syringe interface, an interface cap, and an adjustable tube clamp.

FIG. 7 is a top perspective view of a catheter securement device.

FIG. 8 is a top perspective view of an extension tube secured by the catheter securement device.

FIG. 9 is a front perspective view of a patient wearing a feeding tube and feeding tube extension.

FIG. 10 is a flow diagram of a method for extending a feeding tube.

### DETAILED DESCRIPTION OF PREFERRED EMBODIMENTS

A feeding tube, such as gastric feeding tubes (G-tubes), including percutaneous endoscopic gastronomy (PEG) tubes, jejunostomy feeding tubes (J-tubes), and the like, may be inserted through a stoma in an abdominal wall of a patient into the stomach and/or intestines of the patient. The feeding tube may be used to provide food, nutrition, and/or medication to the patient. The feeding tube may include a tubular member with a feeding lumen travelling the length of the tubular member. A feeding lumen wall may surround the feeding lumen.

A plurality of ports may be coupled to a proximal end of the tubular member. A feeding port may be coaxial with the tubular member. The feeding port may be configured to receive nourishment, such as food in a liquid or other fluid form. The nourishment may be conveyed by the feeding port to the feeding lumen, which may deliver the nourishment to the patient's stomach. A medication port may be configured to convey medication, in a liquid or other fluid form, to the feeding lumen. A balloon port may also be coupled to the proximal end of the tubular member. A securing mechanism may secure at least a portion of the feeding tube within the abdomen and/or stomach of the patient. The securing mechanism may be coupled to a distal tip of the tubular member and may be sized larger than the stoma to prevent removal. In some embodiments, the securing mechanism may be a balloon. An inflation tube may extend from a proximal end of the lumen wall to a distal end of the lumen wall. The inflation tube may couple the balloon port to the balloon to allow the balloon to be inflated using the balloon port.

The length of the feeding tube may cause a portion of the feeding tube external to the patient's body to be entirely or partially covered by the patient's clothing. As a result, the patient's clothing may need to be lifted to access the feeding tube. The patient may consider such accessing of the feeding tube to be annoying, invasive, and/or frustrating. Patients with a measure of dementia or other memory loss, for example, may be particularly sensitive to and/or annoyed by such accessing of the feeding tube. Also, the feeding tube may extend out from the patient's abdomen such that it is perpendicular to the patient's skin surface. In such cases, the feeding tube may be obtrusive, which may lead the patient to pull or adjust the feeding tube, inadvertently and/or unwittingly in some instances. Such pulling or adjustment may cause the feeding tube to be dislodged and/or misplaced. The dislodged and/or misplaced feeding tube may need to be reinserted by a healthcare practitioner and/or may cause infection or injury.

A right-angle bolster may be used to direct the feeding tube along the patient's skin surface so the feeding tube is less obtrusive. A curved bolster lumen may extend through the right-angle bolster. The bolster lumen may be sized such that the tubular member may be passed through the bolster lumen. The bolster lumen may direct the distal tip of the tubular member into the patient's stomach and may direct the proximal end of the tubular member along the patient's skin surface. To so direct the tubular member, an angled formed by a proximal axis of a proximal end of the bolster lumen and a distal axis of a distal end of the bolster lumen may be at least 60 degrees, at least 70 degrees, or at least 80 degrees. A skin cushion may surround the distal end of the bolster lumen and extend radially outward from the distal end of the bolster lumen. The skin cushion may comprise a smooth, flat surface configured to rest against the patient's skin and prevent irritation of the skin near the stoma.

A catheter securement device may also be used to make the feeding tube less obtrusive. The catheter securement device may include an adhesive surface configured to couple the catheter securement device to the patient's skin. The catheter securement device may also comprise one or more tube holders configured to selectively secure the tubular member to the catheter securement device. For example, the one or more tube holders may each comprise a first strap with an aperture and a second strap with locking members configured to removeably interlock with the aperture. The first and second strap may be configured to encircle the tubular member and to frictionally engage with the tubular member when tightened around it.

In some embodiments, the tubular member may be made from a non-deformable, flexible polymer. In such embodiments, the non-deformable polymer may prevent kinks from forming in the tubular member. Alternatively, the tubular member may be made from a deformable, flexible polymer. The deformable polymer may allow obstructions to be removed from the tubular member by pinching or squeezing the tube and forcing the obstruction forward. However, the deformable polymer may be susceptible to kinking. To prevent kinking, the right-angle bolster and catheter securement device may be positioned to maintain the tubular member in a fixed, kink-free position as long as the tubular member is engaged by the right-angle bolster and the catheter securement device.

A feeding tube extension may allow food and medications to be passed to the feeding tube without invasive access to the feeding tube. The feeding tube extension may include an extension tube and a connector. The extension tube may be configured to be cuttable at one or both ends to achieve a desired length. A universal connector may comprise a plurality of tiers with differently sized diameters that allow the universal connector to interface with a plurality of different sized ports including feeding ports and medication ports. However, an aperture of the universal connector and a diameter of the corresponding extension tube may need to be sized for the smallest feeding tube with which the feeding tube extension is designed to interface. Thus for some feeding tubes, the diameter of the aperture and the diameter of the corresponding extension tube may be less than half or less than one-third of the diameter of the feeding lumen. The resulting cross-sectional area may be ten percent to twenty-five percent of the size of the cross-sectional area of the feeding lumen. Significantly more obstructions may result from the reduced cross-sectional area.

In other embodiments, an inner diameter of the extension tube and/or a diameter of a connector lumen may each be configured to be no less than 50%, 60%, 70%, 80%, 90%, or 100% of the diameter of the feeding lumen. The larger size of the extension tube and connector lumen may result in fewer obstructions. To accommodate the larger size of the connector lumen, a diameter of the feeding port may be at least as large the diameter of the feeding lumen. The feeding port may also include a plurality of coaxial circular ridges on an inner surface to interface with the connector. A distal end of the connector may be conically-shaped with a plurality of conical ridges configured to frictionally and mechanically grip the plurality of coaxial circular ridges, thereby removeably coupling the connector to the feeding port. Alternatively, the feeding port may be substantially smooth on the inner surface, and the plurality of conical ridges may frictionally grip the inner surface. In either embodiment, the feeding port may be made of a flexible polymer that stretches radially outward to receive the connector thereby increasing the strength of the frictional engagement between the inner surface and the connector. In some embodiments, the length of the connector and the width of the distal end of the connector may be configured to block the medication port and prevent reflux of liquids out of the medication port.

The proximal end of the connector may be cylindrically shaped to removeably couple with the extension tube. The proximal end of the connector may couple to a distal end of the extension tube by creating a frictional engagement with an inner or outer surface of the extension tube. The extension tube may be made of a deformable, flexible polymer that stretches when the proximal end of the connector is coupled to the extension tube. This stretching may increase the force of the frictional engagement making the connection more secure. Also, the stretching may allow the diameter of the connector lumen to be as large as the diameter of the extension tube. In some embodiments, the proximal end of the connector may be inserted into the extension tube. Alternatively, the extension tube may be inserted into the proximal end of the connector. For a connector configured to be inserted into the extension tube, the diameter of the connector lumen may be substantially uniform for the entire length, or substantially the entire length, of the lumen. A connector configured to receive the extension tube may have a connector lumen with a first diameter at the proximal end equal to an outer diameter of the extension tube and a second diameter at the distal end equal to an inner diameter of the extension tube. In other embodiments, a connector configured to receive the extension tube may have a connector lumen of substantially uniform diameter.

A proximal end of the extension tube may be coupled to a feeding syringe interface. The feeding syringe interface may be cylindrically shaped with an interface lumen travelling the length of the feeding syringe interface. An inner surface of the feeding syringe interface may be tapered, staggered, or the like at the distal and/or proximal ends, so the interface lumen is narrower in the middle than at one or both ends. At its smallest, a diameter of the interface lumen may be configured to be no less than 50%, 60%, 70%, 80%, 90%, or 100% of the inner diameter of the extension tube and/or the diameter of the interface lumen may be configured to be no less than 50%, 60%, 70%, 80%, 90%, or 100% of the diameter of the feeding lumen. The distal end of the feeding syringe interface may be coupled to the proximal end of the extension tube through a frictional engagement. The inner surface may comprise one or more coaxial circular ridges to facilitate the frictional engagement with the extension tube. The tapered and/or staggered inner surface may allow fluids injected by a feeding syringe to experience a substantially constant diameter as they flow from the interface lumen to the extension tube. The extension tube may be inserted into the feeding syringe interface and/or the feeding syringe interface may be inserted into the extension tube. The proximal end of the feeding syringe interface may be configured to frictionally engage with the feeding syringe to hold it in place. Alternatively or in addition, the feeding syringe may be secured to the feeding syringe interface with luer lock. The feeding tube extension may be coupled to the medication port when a luer lock is used. The proximal end of the interface lumen may be configured to receive feeding syringes of a plurality of different sizes.

When the feeding tube extension is not in use, an interface cap and/or an adjustable tube clamp may be used to block fluids from refluxing up and/or out the extension tube. The interface cap may be secured to the extension tube by an extension attachment. The extension attachment may be a loop or ring that encircles the extension tube. The interface cap may also include a cylindrically-shaped interface cover, which goes over the feeding syringe interface to enclose the distal end of the interface. A link may connect the extension attachment to the interface cover. The adjustable tube clamp may have a plurality of clamping tabs to pinch the extension tube closed and block the passage of fluids through the tube. A locking mechanism may allow a user to selectively control positioning of the clamping tabs and lock the clamping tabs in a selected position.

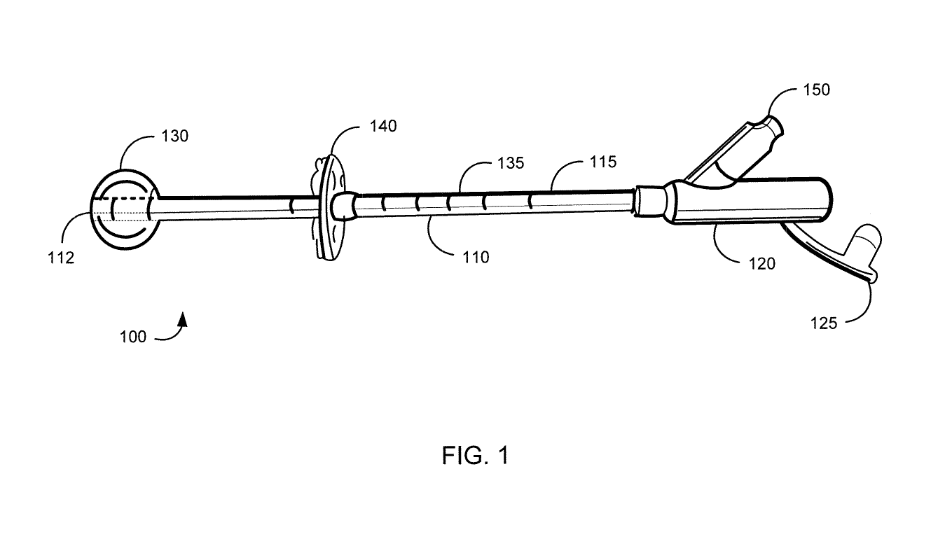

FIG. 1 is a side perspective view of a first gastric feeding tube 100. The gastric feeding tube 100 may comprise a tubular member 110, which defines a feeding lumen to carry liquids, fluid nourishment, aqueous medications, and the like (collectively and generally referred to herein as “fluids”) into a patient's stomach. A feeding port 120 may be configured to receive fluids, which are then delivered to the patient's stomach by a distal tip 112. A balloon 130 may also be located at the distal tip 112. A balloon port 150 may be used to inflate the balloon 130 remotely. An inflation tube 135 may be located in a feeding lumen wall 115. The inflation tube 135 may convey fluids from the balloon port 150 to the balloon 130 to inflate the balloon 130, or the inflation tube 135 may be used to deflate the balloon 130. The feeding port 120 may have a plug 125, which may be inserted into the feeding port 120 to block liquids from being refluxed out of the feeding port 120. The feeding tube 100 may also comprise a straight bolster 140 to rest against the patient's skin. The straight bolster 140 may prevent undesired movement of the feeding tube 100, which can result in irritation of the patient's skin. The straight bolster 140 may cause the feeding tube 100 to protrude straight out from the patient's stomach in an obtrusive manner. For deformable, flexible feeding lumen walls 115, the tubular member 110 may kink closed if the feeding tube 100 is bent at an angle.

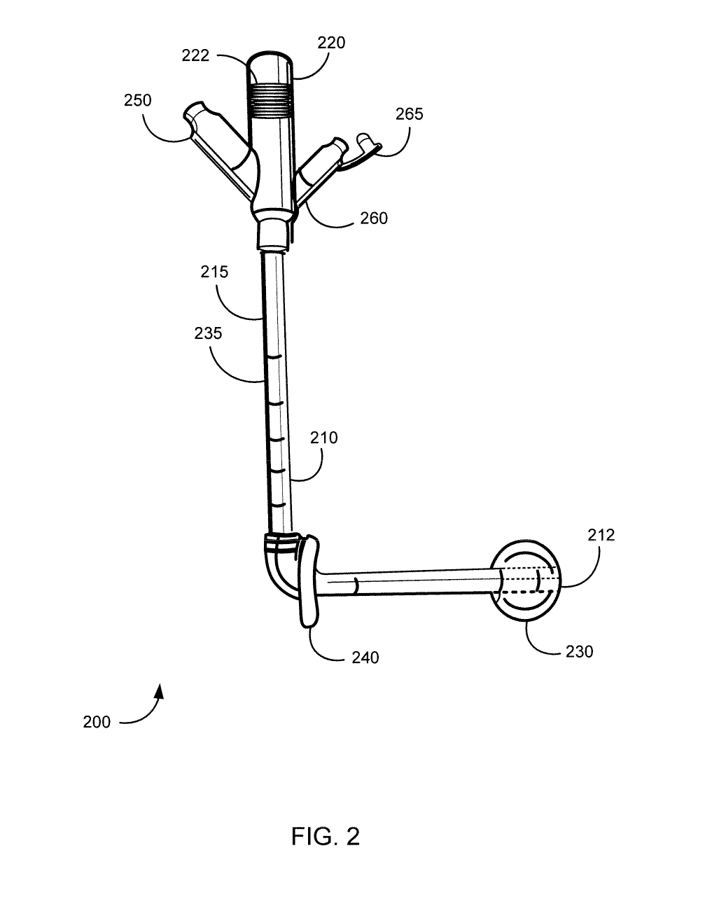

FIG. 2 is a side perspective view of a second gastric feeding tube 200. Like the first gastric feeding tube 100, the second gastric feeding tube 200 may have a tubular member 210, a feeding lumen wall 215, a feeding port 220, a distal tip 212, a balloon 230, a balloon port 250, and a inflation tube 235. The second gastric feeding tube 200 may be inserted through a right-angle bolster 240. The right-angle bolster 240 may angle the second gastric feeding tube 200 so that it is directed parallel, or substantially parallel, to the patient's skin. The right-angle bolster 240 may prevent the second gastric feeding tube 200 from kinking where the feeding tube 200 is bent. The second gastric feeding tube 200 may also have a medication port 260 to receive medication. The medication port 260 may be smaller than the feeding port 220. The medication port 260 may have a plug 265, which can be inserted into the medication port 260. The feeding port 220 may have a plurality of coaxial circular ridges 222 to frictionally engage with connectors and feeding syringes.

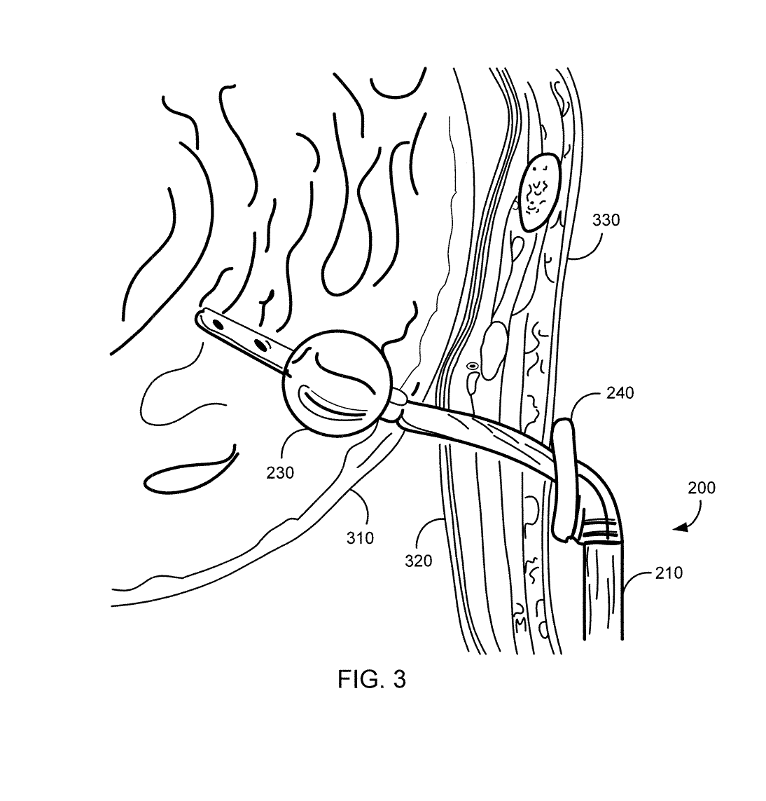

FIG. 3 is a cross-section view of the second gastric feeding tube 200 inserted into a stoma in an abdominal wall 320 and stomach wall 310 of the patient. The balloon 230 may be inflated to secure the feeding tube 200 within the patient. The right-angle bolster 240 may prevent the feeding tube 200 from entering too deeply into the patient or making other undesirable movements. The right-angle bolster 240 may also keep the tubular member 210 in close proximity to the patient's skin 330.

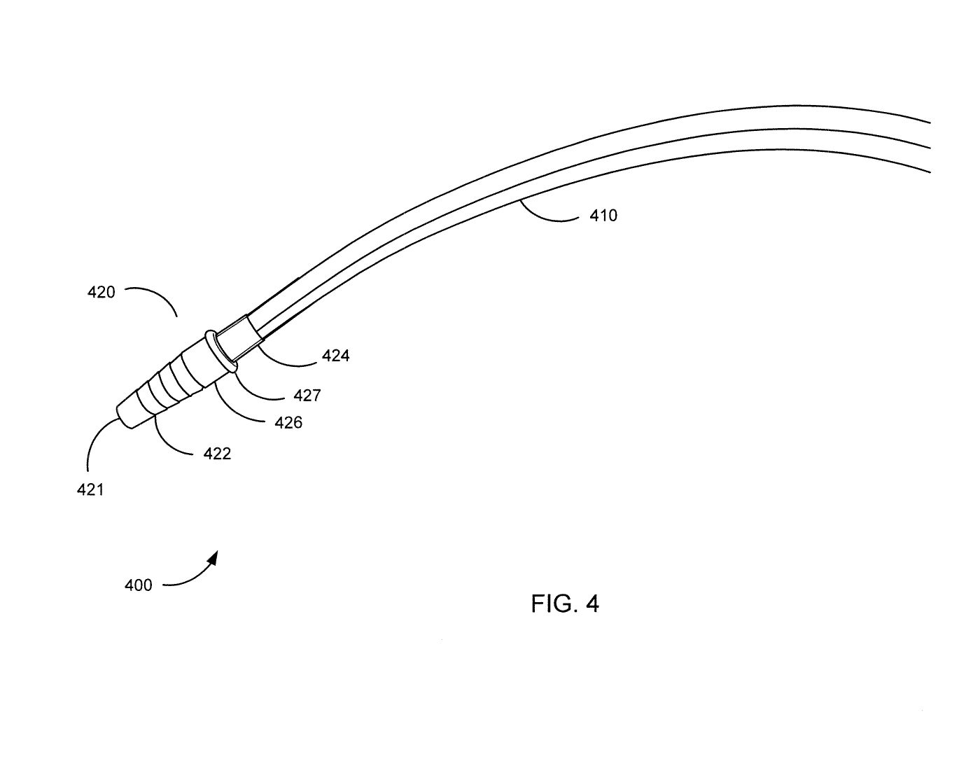

FIG. 4 is a side perspective view of a feeding tube extension 400 for extending the length of a feeding tube 100, 200. The feeding tube extension 400 may include a connector 420 and an extension tube 410. The connector 420 may have a conically-shaped distal end 421 with a plurality of conical ridges 422. The connector 420 may also have a cylindrically-shaped proximal end 424 designed to be inserted into the extension tube 410. A cylindrically-shaped middle section 426 and a lip 427 may join the proximal end 424 and distal end 421 of the connector.

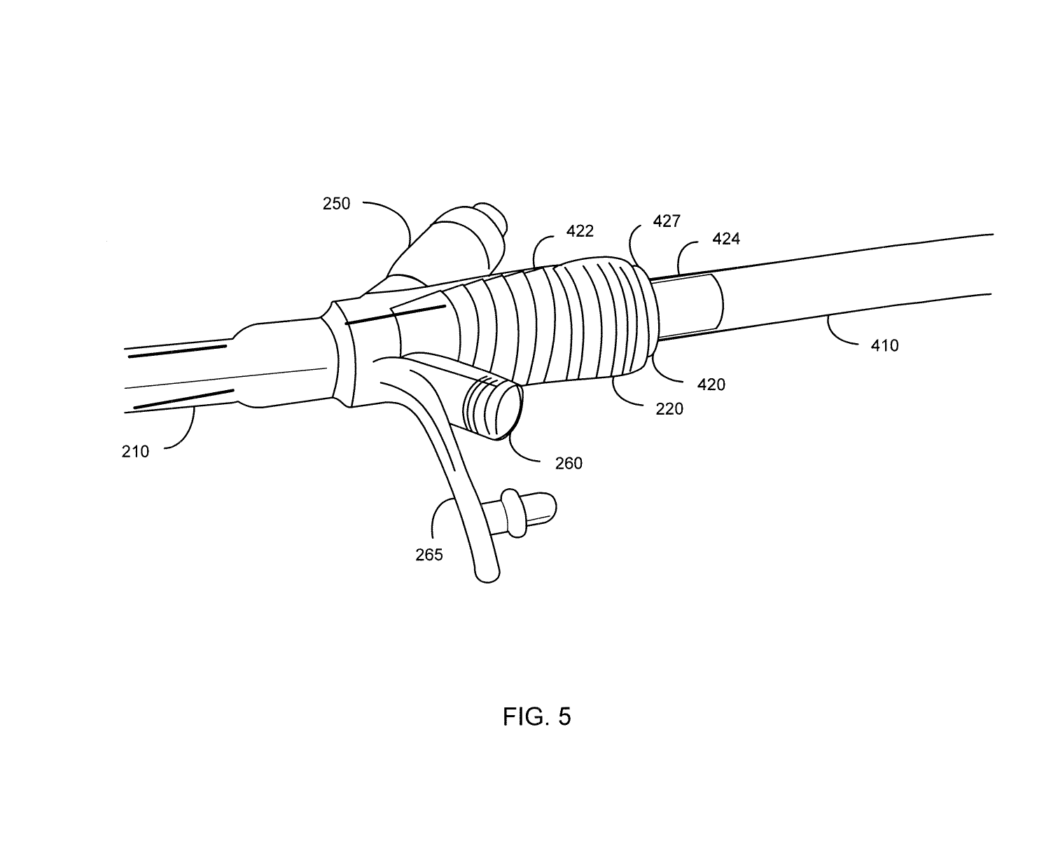

FIG. 5 is a side perspective view of the feeding tube extension 400 coupling to the second gastric feeding tube 200. The plurality of conical ridges 422 may grip and/or frictionally engage with the plurality of coaxial circular ridges 222. The connector 420 may cause the feeding port 220 to stretch and bulge outward. This may increase the frictional force between the connector 420 and the feeding port 220. The lip 427 may limit insertion of the connector 420 into the feeding port 220. In some cases, reflux may have sufficient force to dislodge the plug 265 from the medication port 260. The connector 420 may have a length and width large enough to obstruct the medication port 260 and prevent reflux from coming out of the medication port 260.

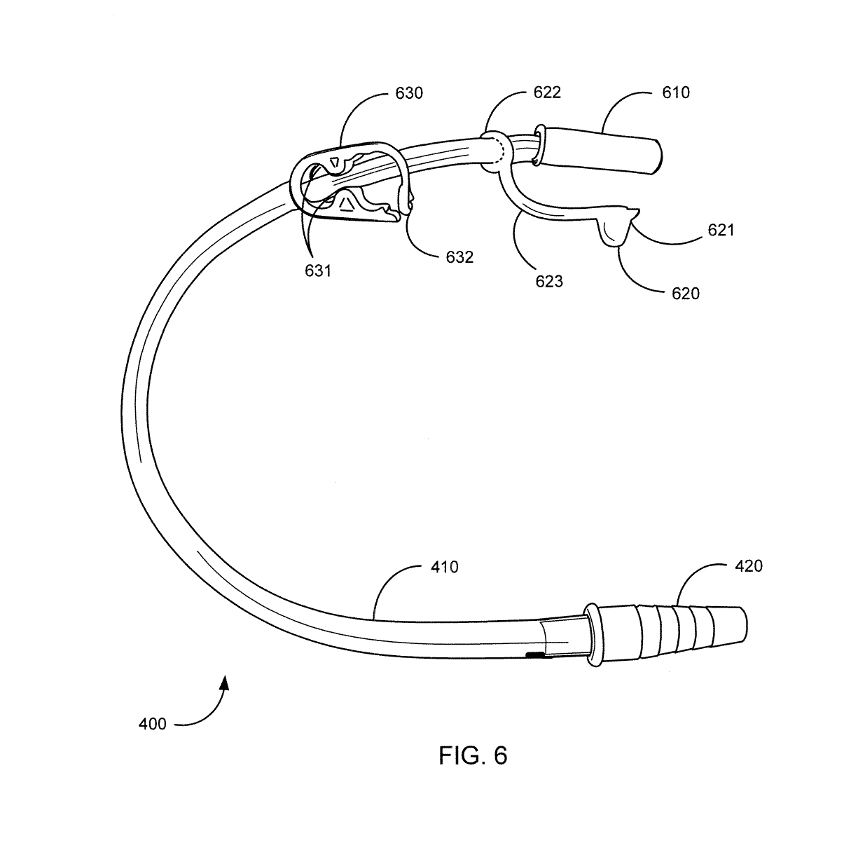

FIG. 6 is a side perspective view of the feeding tube extension 400 with a feeding syringe interface 610, an interface cap 620, and an adjustable tube clamp 630. The feeding syringe interface 610 may be removeably coupled to the extension tube 410. It may be difficult for a feeding syringe to be inserted into the extension tube 410. Accordingly, a distal end of the feeding syringe interface 610 may be configured to couple to the extension tube 410, and a proximal end of the feeding syringe interface 610 may be configured to receive a feeding syringe. When the patient is not being fed, the interface cap 620 may be used to block a lumen of the feeding syringe interface 610. The interface cap 620 may include a cylindrically-shaped interface cover 621 to enclose the interface lumen, a loop-shaped extension attachment 622 to couple the interface cap 620 to the extension tube 410, and a link 623 to couple the interface cover 621 to the extension attachment 622. Additionally, an adjustable tube clamp 630 may be used to pinch the extension tube 410, thereby blocking flow through the extension tube 410. The adjustable tube clamp 630 may comprise a plurality of clamping tabs 631 to pinch the extension tube 410 and a locking mechanism 632 to selectively control positioning of the clamping tabs 631.

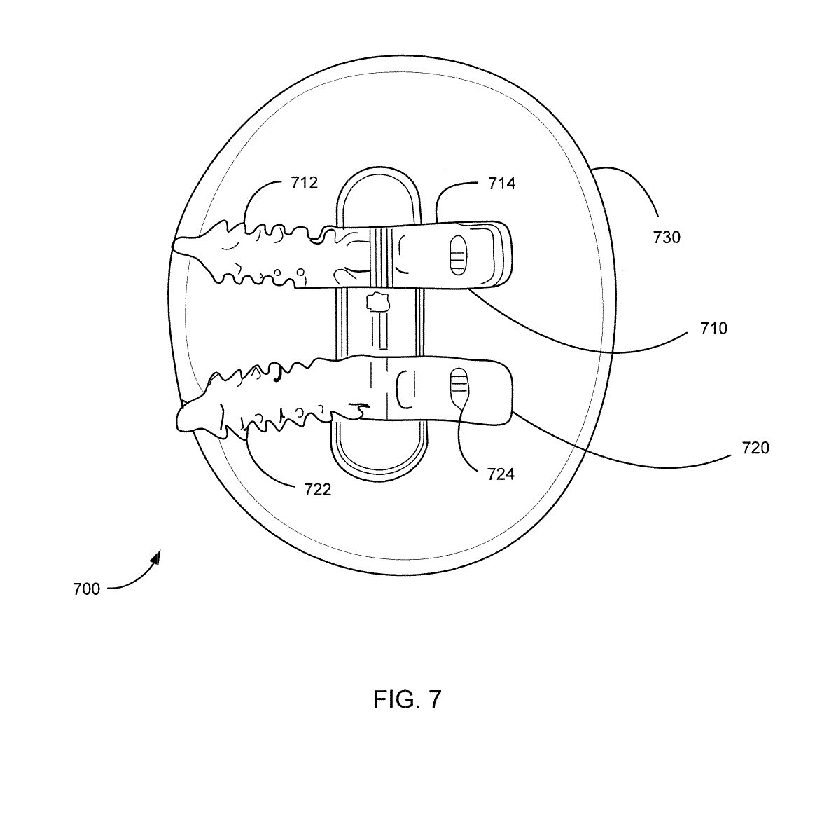

FIG. 7 is a top perspective view of a catheter securement device 700. The catheter securement device may comprise one or more pairs of straps 710, 720. A first strap 714, 724 in each pair 710, 720 may comprise apertures, and a second strap 712, 722 in each pair 710, 720 may comprise locking members configured to removeably interlock with the apertures. The straps and/or locking members may be made from a flexible polymer.

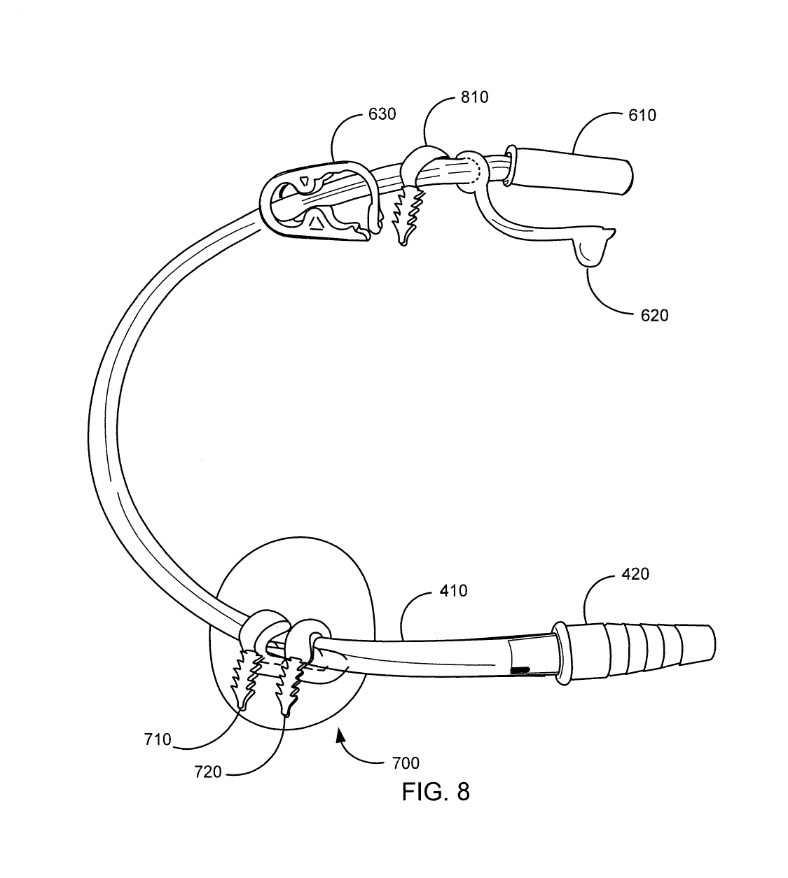

FIG. 8 is a top perspective view of an extension tube 410 secured by the catheter securement device 700. Each pair of straps 710, 720 may be configured to secure the extension tube 410 to the catheter securement device 700 by encircling and frictionally engaging the extension tube 410. An adhesive surface 730 may couple the catheter securement device 700, for example, to the patient's skin. The catheter securement device 700 may also be used to secure the tubular member 110, 210 of the feeding tube 100, 200 to the patient's skin. An additional catheter securement device 810 may be used to secure the proximal end of the extension tube in a desired location, which may also position the feeding syringe interface in a desired location. The additional catheter securement device 810 may comprise a tube holder, such as a pair of straps. The additional catheter securement device 810 may also comprise an adhesive surface, a safety pin, and/or the like to secure the additional catheter securement device 810 to the patient's clothing.

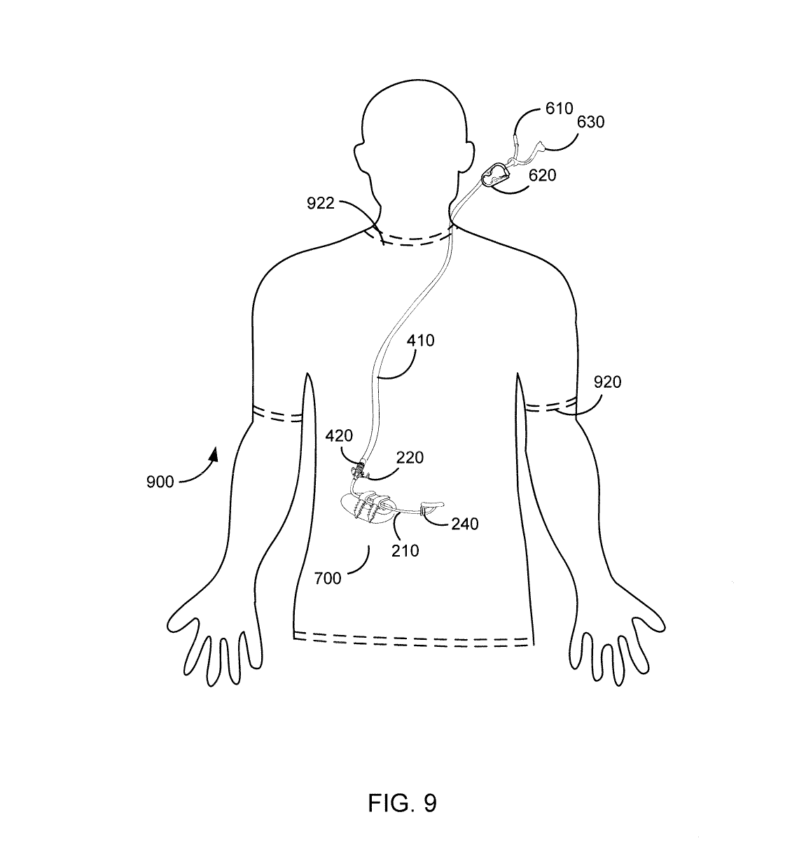

FIG. 9 is a front perspective view of a patient 900 wearing a feeding tube 200 and feeding tube extension 400. The right-angle bolster 240 may direct the tubular member 210 into the patient's stomach. The exposed portion of the tubular member 210 may be secured to the patient's skin by the catheter securement device 700. The right-angle bolster 240 and catheter securement device 700 may prevent the tubular member from moving or kinking. The feeding port 220 may couple to the connector 420. The extension tube 410 may travel up the patient's abdomen and emerge from the collar 922 of the patient's shirt 920. The feeding syringe interface 610 may then be located near the patient's head making it easier for a healthcare practitioner to locate the feeding syringe interface 610 and inject food. The location near the patient's head may also facilitate interaction between the patient and healthcare practitioner during feeding.

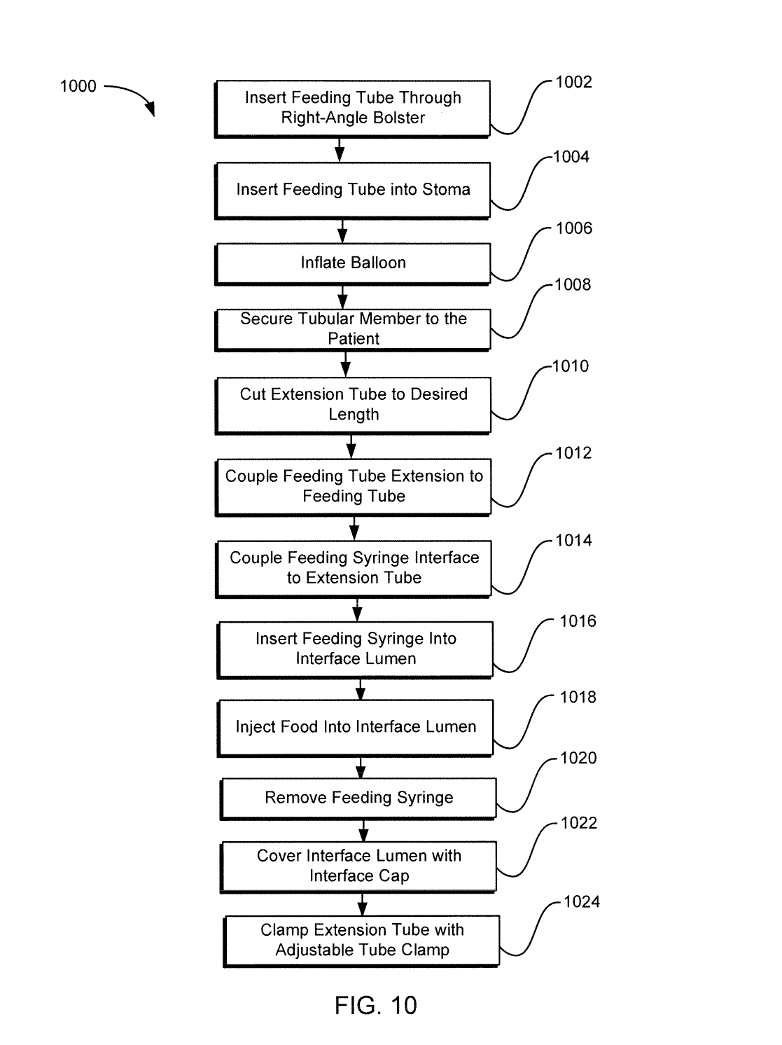

FIG. 10 is a flow diagram of a method 1000 for extending a feeding tube. The feeding tube 100, 200 may be set up before, during, and/or after preparing the feeding tube extension 400. To set up the feeding tube 100, 200, the feeding tube 100, 200 may be inserted 1002 through the right-angle bolster 240. Then, the feeding tube 100, 200 may be inserted 1004 into a stoma in an abdominal wall of a patient. The balloon 230 may be inflated 1006 to secure the feeding tube 100, 200 in the patient. The exposed portion of the tubular member 110, 210 may be secured 1008 to the patient using the catheter securing device.

To prepare the feeding tube extension 400, the extension tube 410 may be cut 1010 to a desired length. A connector 420 may be coupled to the extension tube 410. The connector 420 of the feeding tube extension 400 may be coupled 1012 to the feeding tube 100, 200. The feeding syringe interface 610 may be coupled 1014 to the extension tube 410. The feeding tube 100, 200 and extension 400 may then be used to feed the patient. To feed the patient, a feeding syringe may be inserted 1016 into the interface lumen. The feeding syringe may be used to inject 1018 food into the interface lumen. The feeding syringe may afterwards be removed 1020 from the interface lumen. The interface lumen may be covered 1022 using the interface cap 620, and/or the extension tube 410 may be clamped 1024 closed by the adjustable tube clamp 630.

It will be understood by those having skill in the art that many changes may be made to the details of the above-described embodiments without departing from the underlying principles of the disclosure. The scope of the present disclosure should, therefore, be determined only by the following claims.

1. A feeding tube extension for extending a gastric feeding tube comprising a feeding port, the feeding tube extension comprising:
an extension tube configured to convey fluids to the gastric feeding tube, wherein an extension tube inner diameter is no less than 50% of an inner diameter of the gastric feeding tube;
a connector configured to removeably couple with the feeding port and to removeably couple with the extension tube; and
a feeding syringe interface defining an interface lumen therethrough, wherein a proximal end of the interface lumen is configured to removeably receive a feeding syringe.

2. The feeding tube extension of claim 1, wherein the connector comprises a conically-shaped distal end including a plurality of conical ridges configured to frictionally engage the feeding port.

3. The feeding tube extension of claim 1, wherein the extension tube inner diameter is no less than 80% of the inner diameter of the gastric feeding tube.

4. The feeding tube extension of claim 1, wherein the connector comprises a cylindrically-shaped proximal end configured to be removeably inserted into the extension tube.

5. The feeding tube extension of claim 4, wherein the extension tube comprises a deformable, flexible polymer, and wherein the extension tube is configured to stretch about the cylindrically-shaped proximal end.

6. The feeding tube extension of claim 1, wherein the connector defines a connector lumen extending from a proximal end of the connector to a distal end of the connector, and wherein a connector lumen diameter is no less than 50% of the inner diameter of the gastric feeding tube.

7. The feeding tube extension of claim 1, wherein the connector lumen diameter is substantially uniform for substantially an entire length of the connector lumen.

8. The feeding tube extension of claim 1, wherein the extension tube inner diameter is no less than 50% of a diameter of a feeding lumen.

9. The feeding tube extension of claim 8, wherein a diameter of the feeding port is at least as large as the diameter of the feeding lumen.

10. The feeding tube extension of claim 1, wherein a distal end of the interface lumen is configured to removeably receive the extension tube, and wherein an interface lumen diameter is no less than 50% of the extension tube inner diameter.

11. The feeding tube extension of claim 1, further comprising an interface cap configured to enclose a distal end of the feeding syringe interface.

12. The feeding tube extension of claim 1, further comprising an adjustable tube clamp configured to pinch the extension tube to block passage of the fluids.
